(19) United States
(12) Patent Application Publication
(10) Pub. No.: US 2011/0119300 A1
(43) Pub. Date: May 19, 2011

(54) Method Of Generating An Analytical Data Set For Input Into An Analytical Model

(75) Inventor: Erik Marcade, Paris (FR)

(73) Assignee: KXEN, Suresnes (FR)

(21) Appl. No.: 13/003,271

(22) PCT Filed: Jul. 9, 2008
(86) PCT No.: PCT/IB2008/054156

§ 371 Date: Jan. 7, 2011

(51) Int. Cl. G06F 17/30

(52) U.S. Cl. 707/769; 707/E17.009; 707/E17.014

(57) ABSTRACT

A method of and a system for generating a dataset from data stored in at least one data base, for input into an analytical model. The method comprises the steps of: defining a time stamped population comprising a plurality of tuples, each tuple comprising an entity identifier of an entity for analysis, and at least one reference time stamp associated with the corresponding entity identifier; and creating a dataset by generating at least one time dependent attribute value for each entity identifier from data associated with said entity identifier in the at least one database, the or each time dependent attribute value representing a time dependent parameter of the corresponding entity identifier and being generated according to a corresponding attribute definition, wherein the or each time dependent attribute value is generated as a function of the corresponding time stamp. Preliminary steps of defining the entity as the object of analysis of the analytical model; and defining an analytical record for describing the entity, the analytical record comprising at least one time dependent attribute defined by the corresponding attribute definition are also described.

### FIELD OF THE INVENTION

The present invention relates to a method of generating a data set from data stored in at least one database. In particular, the invention relates to a method of automatically generating a standardized data set for inputting to an analytical model.

### BACKGROUND OF THE INVENTION

The task of analysing recorded data for extracting useful information has become increasingly difficult with the ever increasing volume and complexity of data in modern industry, science and business. The process of sorting through vast amounts of data and producing relevant information, often referred to as data mining, can be extremely tedious and time consuming. Automatic data analysis using more complex and sophisticated tools for producing useful information from vast amounts of stored data has become more and more common. Through the use of sophisticated algorithms, analysts can, for example, identify key attributes of business processes, predict client behaviour and use this information to target business opportunities. Such mathematical and statistical technique implementations are known as advanced analytical engines or analytical models, and may be classified under functions such as, for example, classification, regression, clustering, segmentation, attribute importance, association rules, and times series forecasting. Development of such models is however a costly and time consuming process while keeping the models up to date requires further investment of time and costs.

Data generated by industries and businesses can be stored in databases such as operational databases, data warehouses or data marts. Data marts are typically tailored to store data oriented to a specific purpose or subject. Data warehouse design principles generally require data to be stored in its most basic form, as “Atomic” data, and they generally contain a significant number of database tables consisting of raw data columns.

Operational databases are generally optimized to preserve data integrity and speed of recording of business transactions through use of database normalization. Data warehouses are optimized for speed of data retrieval. Frequently data in data warehouses are denormalised via a dimension-based model. Also, to speed data retrieval, data warehouse data is often stored multiple times—in their most granular form and in summarized forms known as aggregates.

Both operational databases and data warehouses typically follow an entity-relationship data schema and are usually based on Relational DataBase Management Systems (RDBMS). There is a vast array of tools and techniques to extract, transform, and load (ETL) data between repositories, and there is a wealth of techniques for performing data manipulations, generally using a standard data and meta-data query language known as Structured Query Language (SQL).

Data for use in an analysis may be gathered from multiple data sources, from data recorded by an industry or business in operational databases and data warehouses, as well as from third party data providers. Third party data providers may supply different types of data such as demographic data lifestyle data, customer interests and the like.

To operate effectively, advanced analytical modelling techniques require data to be fed to the model in a simplified form such as a single table known as an analytical data set containing a vision of the entities of interest at a given time. Analytical data sets may be regarded as virtual data tables where each row represents a given entity of interest and columns are made up of attributes, also known as analytical variables or explanatory values, for describing the different entities. An analytical record is the group of attributes used to describe the entity. An analytical data set can sometimes be referred to as a virtual flat file. Such tables should be as complete as possible for the analysis and generally require more sophisticated data attributes than the raw data attributes stored in the source databases. An attribute definition or expression describe how a given attribute is derived from the operational data for an analytical record and may be comprised of primitives and/or computational expressions. Primitives are generally base attributes while computational expressions may include predicates, aggregates or other functions. An entity is defined as the object of analytical interest and may include, for example: customers, products, shops etc. In customer analytics, an analytical data set is sometimes expressed as the ‘360’ view of the customer. A customer can be described by thousands of attributes that can be computed from atomic data contained within a customer data warehouse. Effective analysis necessitates easy reconstruction of these attributes for a given population of customers at a given time.

Recent mathematical developments and the spread of best practice methods have allowed the degree of automation of analytical modelling techniques to be improved. Mathematical and statistical engines still require, however, a repeatable and industrialized process in order to create the analytical data sets used as their inputs and to maintain these data sets through time.

U.S. Pat. No. 7,047,251 describes a standardized customer application for inputting customer data into analytical models. U.S. Pat. No. 7,272,617 relates to the creation of an analytical data set for modelling in a customer relationship management system. These systems do not, however, deal in an automated manner with attributes describing customer entities, which may vary over time.

### SUMMARY OF THE INVENTION

Accordingly, it is an object of the present invention to provide an improved method of automatically generating an analytical data set for input into an analytical model.

In general terms, the invention sets out to provide a method of and a system for automatically generating a standardised dataset for input to an analytical model by providing a cross product of a time stamped population of an entity of interest and an analytical record describing the entity.

In accordance with a first aspect of the invention, there is provided a method of generating a dataset from data stored in at least one data base, for input into an analytical model, the method comprising the steps of: defining a time stamped population comprising a plurality of tuples, each tuple comprising an entity identifier of an entity for analysis, and at least one reference time stamp associated with the corresponding entity identifier; and creating a dataset by generating at least one time dependent attribute value for each entity identifier from data associated with said entity identifier in the at least one database, the or each time dependent attribute value representing a time dependent parameter of the corresponding entity identifier and being generated according to a corresponding attribute definition, wherein the or each time dependent attribute value is generated as a function of the corresponding time stamp.

In this way, the method according to the invention provides a standardised input for an analytical model. Since advanced analytics techniques can now be used in very high dimensional space (some techniques, for example, automatically handle thousands of attributes describing an entity), the method of the present invention addresses an unfulfilled need for automatically creating very wide analytical data sets that manage time dependent attribute computations in a formal way, requiring a minimal amount of programming knowledge and human intervention.

The proposed automation method, dealing with time dependent attributes, is beneficial and effective for integrating data mining tasks into a scheduled environment as well as for allowing the implementation of back-testing facilities without the need for specific programming, and is of importance for the overall productivity of data mining activities.

The method may include the preliminary steps of defining the entity as the object of analysis of the analytical model; and defining an analytical record for describing the entity, the analytical record comprising at least one time dependent attribute defined by the corresponding attribute definition. Naturally, the analytical record may also include one or more attributes which are non time dependent.

Features of embodiments of the method of the invention may include:
the or each attribute definition being expressed in structured query language for execution by a database management system;
the time stamped population being defined by structured query language for execution by a database management system;
the or each time dependent attribute comprising at least one data manipulation operation on data of the one or more databases, selected from the group consisting of: extraction, transformation, calculation, aggregation and joining of data.
defining one or more attribute groups wherein each attribute group comprises a set of one or more attributes with similar characteristics.

A second aspect of the invention provides a method of analysing data using an analytical model, the method comprising generating a data set for input to the analytical model according to the method hereinbefore described; inputting the dataset to the analytical model and performing analysis of data according to the analytical model.

A third aspect of the invention provides a method of predicting the behaviour of an entity, comprising analysing data using an analytical model according to the method hereinbefore described.

A fourth aspect of the invention provides a method of training, scoring or back-testing an analytical model comprising analysing data using the analytical model according to the method hereinbefore described.

The methods according to the invention may be computer implemented. They may be implemented in software on a programmable apparatus. They may also be implemented solely in hardware or in software, or in a combination thereof.

According to a fifth aspect of the invention there is provided a system for generating a data set from data stored in at least one data base, for input into an analytical model, the system comprising: an input for receiving data from a database;

a processor for defining a time stamped population comprising a plurality of tuples, each tuple comprising an entity identifier of an entity for analysis, and at least one reference time stamp associated with the corresponding entity identifier; and for creating a dataset by generating at least one time dependent attribute value for each entity identifier from data associated with said entity identifier in the at least one database, each attribute value representing a time dependent parameter of the corresponding entity identifier and being generated according to an attribute definition, wherein the or each time dependent attribute value is generated as a function of the corresponding time stamp; and an output for transmitting the data set to the analytical model.

Features of embodiments of the system of the invention may include:
the processor being operable to define the entity as the object of analysis of the analytical model; and to define an analytical record for describing the entity, the analytical record comprising at least one time dependent attribute defined by the corresponding attribute definition; and
a user interface for defining the time stamped population, the analytical record, or at least one attribute making up the analytical record.

Since the present invention can be implemented in software, the present invention can be embodied as computer readable code for provision to a programmable apparatus on any suitable carrier medium. A tangible carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:—

FIG. 1 is a schematic diagram of a system for automatically generating an analytical data set according to an embodiment of the invention;

FIG. 2 illustrates a set of operational data tables stored in the database of FIG. 1;

FIG. 3 is a flowchart illustrating steps of a method performed for automatically generating an analytical data set according to an embodiment of the invention;

FIG. 4A illustrates two example tables of a time stamped population defined according to the embodiment of FIG. 1;

FIG. 4B illustrates two examples of an analytical data set generated according to the embodiment of FIG. 1;

FIG. 5 is a schematic diagram of a method of generating an analytical data set according to an embodiment of the invention; and

FIG. 6 is a flow chart illustrating steps of a method of analysing data according to an embodiment of the invention.

### DETAILED DESCRIPTION

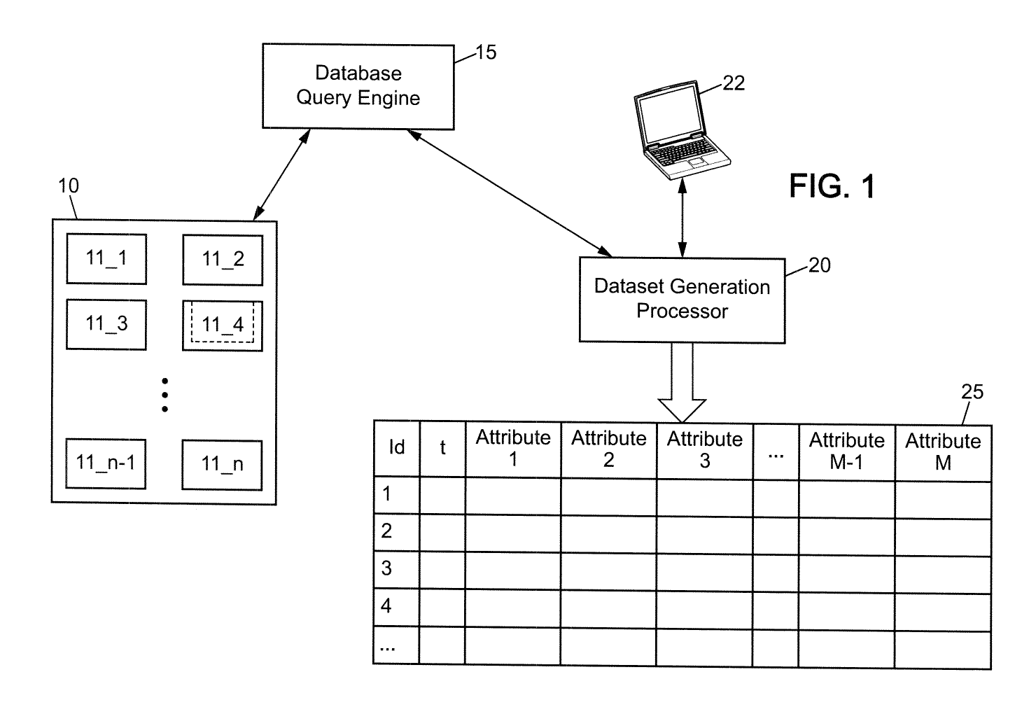

A first embodiment of the method according to the invention will be described with reference to FIGS. 1 to 5.

With reference to FIG. 1, data is stored in multiple data tables 11_1, 11_2, . . . 11_{—}n of a database 10. Database 10 may be any data storage system, for example an operational database or a data warehouse. In order that useful information can be extracted from the arrays of data, the relevant data is extracted or derived from the data stored in the multiple data tables 11_1, 11_2, . . . 11_{—}n, by means of a database query engine 15 receiving instructions from a dataset generation processor 20 and transformed by the dataset generation processor 20 into an analytical data set 25 for input to an analytical model. User interface 22 can be used to input data or to define parameters for generation of the data set.

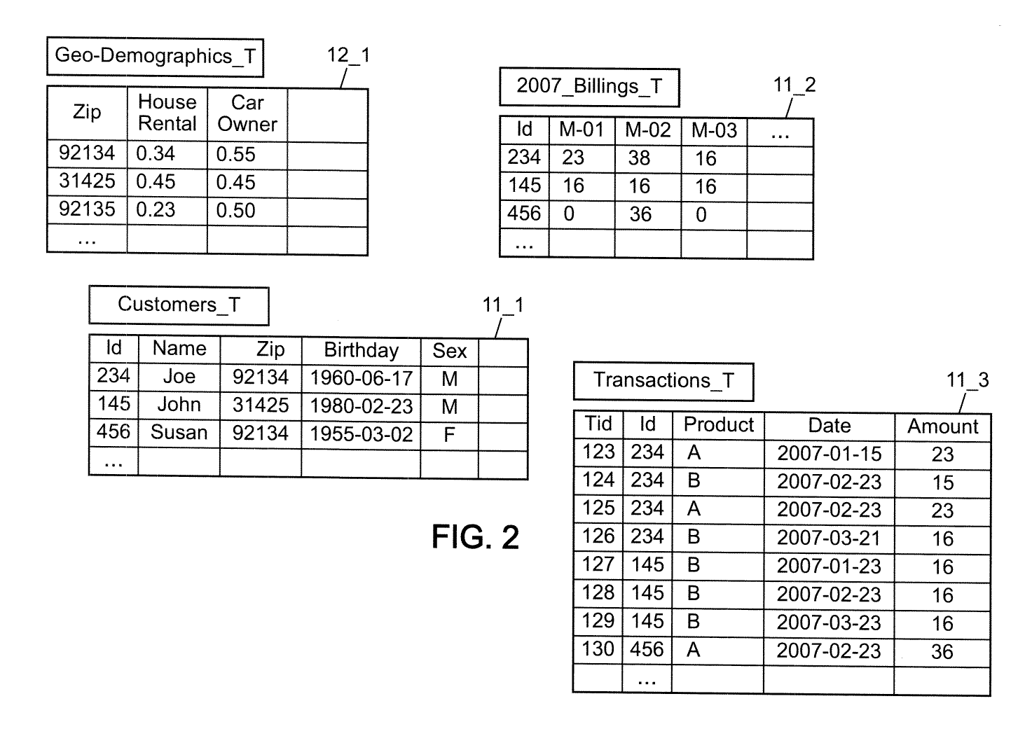

FIG. 2 illustrates examples of data tables 11_1, 11_2, 11_3,12_1, from which relevant data for analysis may be retrieved. Table 11_1, denoted “Customers_T”, contains descriptive data about customers as entities, and has 3 examples of customers: Joe, John, and Susan, having entity identifiers Id 234, 145 and 456, respectively. Each customer is described by the data attributes of name, home Zip code, birth date and sex. Table 12_1 contains demographical data, called “Geo-Demographics_T”, which may be collected from any third party data provider (such as, for example, Experian or Acxiom,) and which contains attributes such as the ratio of households in a given Zip code who are renting their house, and the ratio of households owning at least one car in the corresponding Zip-code. It will be appreciated that these examples are provided for the sake of illustration and other types of data may be contained in such tables. Table 11_2, denominated “2007-Billings_T”, contains some pre-aggregated billing information for each customer for the year 2007. This table contains 12 columns, one for each month showing the amount due by each customer for that month. Table 11_3, called “Transactions_T”, contains transaction data, a row indicating a single purchase of a customer of a given product at a given date for a given amount. For the sake of this illustrative example, we have shown the transactions for the 3 customers in the 3 first months of the year 2007. It can be seen that the billing information in Table 11_2 correlates with the transactions of Table 11_3.

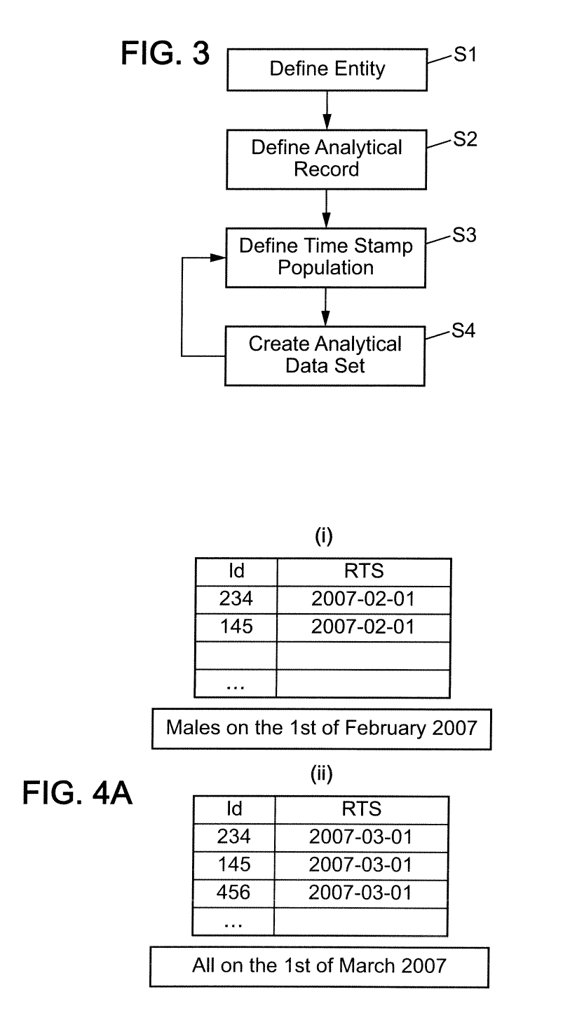

With reference to FIG. 3, the first step S1 of generating an analytical dataset according to this embodiment of the invention is to define the entity of interest to the advanced data analysis process to be performed by the analytical model. In the example shown in FIG. 2, the user may specify the notion of ‘customer’ as the entity of interest. This is done by defining that the full list of ‘customers’ may be found in Table 11_1, ‘Customers_T’ using the attribute ‘Id’. It should be noted that properly defining the entity can be more complex. For example, a retail bank may consider for some analytical applications that the entity should be the ‘household’, and for other advanced analytical projects, the entity may be the ‘account owner’. The same entity may be used for different analytical projects.

As illustrated in FIG. 3, the next step S2 of the method according to this embodiment of the invention is to define an analytical record for describing the entity of interest. Each entity can be associated with at least one analytical record. An analytical record is defined by a list of attributes that are provided through data manipulation expressions according to respective attribute definitions, including, but not limited to direct extraction of attributes from a data table, join operations to fetch information contained in tables, creation of new variables using an expression editor, calculations, transformations or complex aggregations. The formal operations in the analytical record may be expressed in SQL for execution by the database query engine 15 to retrieve the data from the database 10 shown in FIG. 1. SQL is a standard interactive and programming language well known in the art for querying and modifying data and managing databases and therefore no further explanation of this technique is necessary for the understanding of the present invention. The expressions of formal operations can refer to previous attributes of the analytical record, to a variable called the ‘reference time stamp’ denoted hereinafter as RTS, or to user defined prompts that can be attributed values at the time of the analytical data set creation. In the example shown in FIG. 2, the user may decide to populate the analytical record associated with the ‘customer’ entity with the attributes contained in Table 11_1 ‘Customers_T’. While, the attribute ‘Sex’ can be considered as valuable information to be used in predictive analytics modelling, the attribute ‘Birthday’ may be replaced by the notion of ‘Age’. To achieve this, the user can edit the definition of the analytical record to make ‘Birthday’ non-visible and add a computed column using the expression editor to add a new variable called Age that will be derived, for example, from the attribute definition or expression: <<convert(RTS-BirthDate) in years>>. The user may also decide to join all the geo-demographics data contained in the “Geo-Demographics_T” table 12_1 using the ‘Zip’ code attribute as a join key.

The user may wish to add a new attribute that will describe a customer at a given date with the amount billed on the previous month called PM_Billing before this date. For this, he can join data contained in the “2007_Billings_T” Table 11_2 and an equivalent table “2006_Billings_T” containing data for the year 2006 based on the customer identifier (“Id”) and define the attribute with an expression following a switch statement such as: <<switch on (RTS), when [month(RTS)=01 and year(RTS)=2007], return 2006_Billings_T.M12, when [month(RTS)=02 and year(RTS)=2007], return 2007_Billings_T.M01, when [month(RTS)=03 and year(RTS)=2007], return 2007_Billings_T.M02, . . . >>. The user may also decide to define an attribute by computing some aggregates based on the number of purchases that have taken place over the two previous months for each of the products. The number of purchases of product A during the previous month could be called “PM_ProductA” and may, for example, be expressed as: <<count_filtered_aggregate(“Transactions_T, “T.Id”, “Id”, “Date”, RTS-1 month, RTS, “Product”, ‘A’)>> which can be translated as: count the number of transactions contained in the “Transactions_T” table when joined on columns “Customers_T.Id” and “Transactions_T.Id” where the “Date” of the transactions must be between RTS-1 month and RTS, keeping only transactions where the attribute “Product” is equal to “A”.

The resulting analytical data set will contain at least one time dependent attribute. In the present example four attributes are time dependent: Age, PM_Billing, PM_Product_A and PM_Product_B.

It will be appreciated that the method according to the invention is not limited to a specific language expression for defining attributes; these expressions can be made by SQL or provided by a graphical user interface. It will also be appreciated that the method according to the invention is not limited to specific data manipulations. The concept of the method according to the invention is that at least one data manipulation for definition of an attribute refers to a specific date value used in time dependent expressions to generate the desired time dependent attributes.

The attributes of the analytical records may or may not be grouped into homogeneous attributes sometimes referred to as ‘Domains’. A domain is a group of attributes having similar characteristics describing a homogeneous section of an entity. For example, an analytical record describing customers may have a demographic domain or a behavioural domain. Domains may also be created for data generated by the analytical model, for example, score and segment domains.

The initial two steps (S1&S2) of the method may be implemented with an easy to use expression editor or some programming language expertise. It will be appreciated, however, that steps S1 and S2 are not required each time the method according to the invention is run. The first time an analytical project deals with a specific entity, a user defines this entity and the associated analytical record. All subsequent projects on the same entity may reuse the Analytical Record once it has been defined. Optionally, several analytical records focusing on very different domains may be associated with one entity.

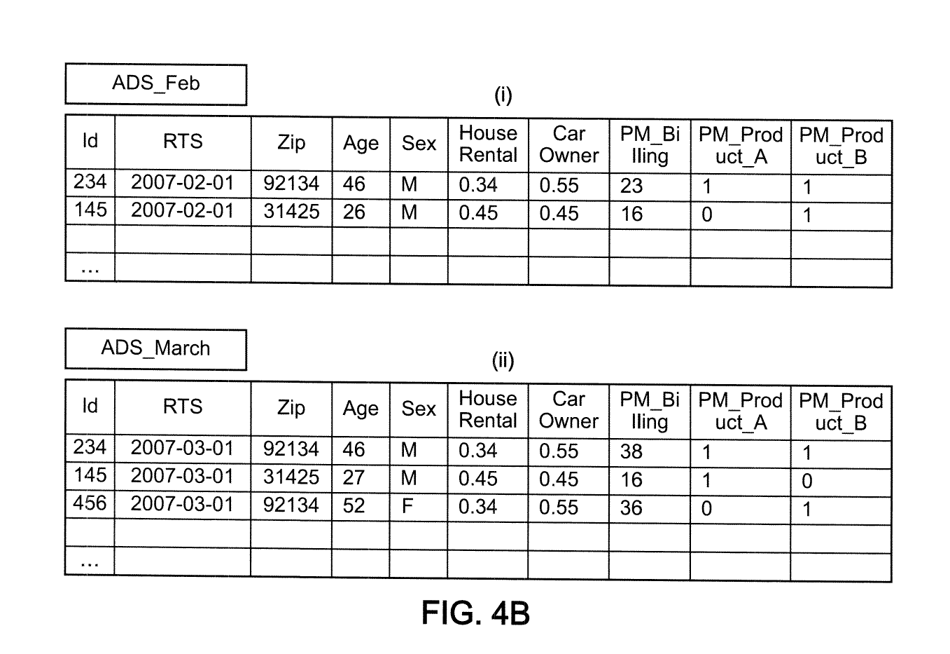

Referring to FIG. 3, the third step (S3) in the process is to define a Time Stamped Population. Defining the time stamped population can be seen as a data manipulation technique that generates a table with at least two columns: the first column contains the list of the values of the entity identifiers of interest, and the second column contains the values of the time stamp associated with each entity identifier that the user wishes to use as the reference time stamp for this entity. Each row of the time stamped population thus comprises a data group or tuple of an entity identifier and at least one reference time stamp. For example, as illustrated in FIG. 4A(i), the user may ask for a time stamped population of ‘Males on the 1st of February 2007’ from the data shown in FIG. 2. The user may use a time stamped population editor interface in order to generate, for a given entity, the list of identifiers of the population of interest, and the associated time stamp that he wishes to use to compute the time dependent attribute values of the analytical record. In the provided example, the user has decided to filter a population containing only males (with Sex=‘M’), and to compute all time dependent attributes of the analytical record using as a reference time stamp “1st of February 2007”. Another example of a time stamp population, proposed for the sake of explanation, contains all customers (male and female) associated with a time stamp of “March 1st 2007” as illustrated in FIG. 4A(ii). Defining the time stamped population is the only operation required in order to regenerate the desired values of attributes for the desired populations for a different time reference. There is no need to redefine the analytical record. Both examples of these time stamped populations are illustrated in FIG. 4A. Graphical editors provided via user interface 22 can provide easy creation of time stamp populations from filtering the list of desired entities, from a composition of previously existing time stamp populations such as by union, intersection and difference; or from Cartesian products between a list of selected dates and a list of entity identifiers. The definition of the time stamp attribute may use, for example, a system of prompts that can ask for a value to be used to fill the column only at run time, or may automatically insert the current date. The time stamp can be used to compute an attribute value or to look for a value contained in a specific column depending on time.

It will be appreciated that in some embodiments of the invention an entity identifier may have more than one reference time stamp, or different entity identifiers may be associated with different time stamps. A given entity may be represented at different time stamps in a single time stamped population.

The fourth step (S4) is the generation of the Analytical Data Set. This step is fully automated when provided with a given Analytical Record and a corresponding time stamped population for the same entity. In this embodiment of the invention, this step is implemented through generation of SQL statements by the dataset generation processor 25. Execution of these SQL statements by the database query engine 15 results in retrieval of data from the database 10 for populating the cells of the analytical dataset and creation of the analytical data set containing at least one attribute value dependent on the RTS of the time stamped population.

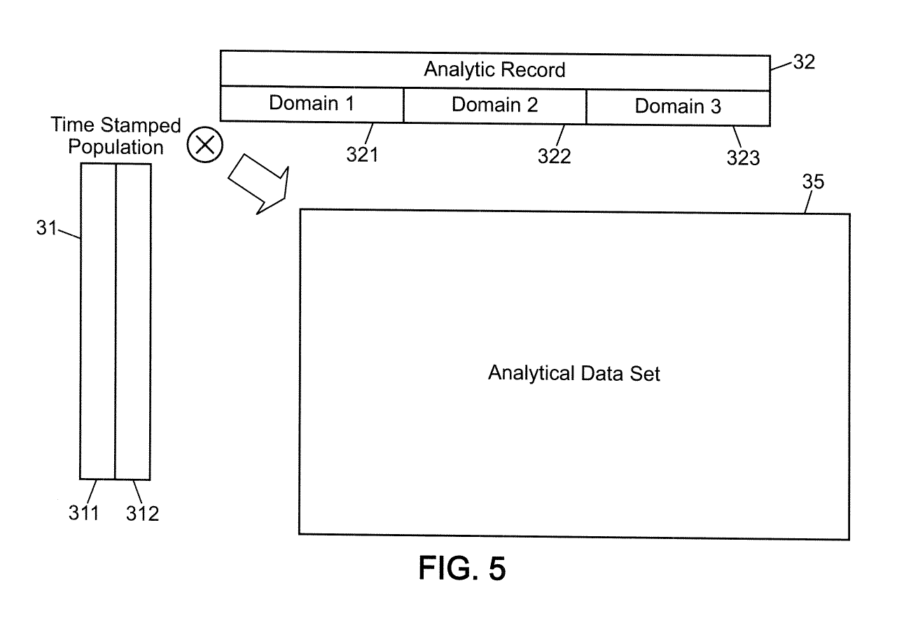

As illustrated in FIG. 5, the resulting analytical data set 35 can be seen as a cross product of the time stamped population 31 comprising an entity id column 311 and a time reference column 312, and the analytical record 32 comprising attribute columns grouped into three Domains: Domain 1, Domain 2 and Domain 3.

The SQL statements executed by the database query engine 15 may be provided as very complex ‘select’ statements returning a volatile result set, only available at the time of the query, or the resulting select statement may be executed in order to create a dataset according to the choice of the user. In the resulting analytical table as shown in FIG. 4B, the case of the customer 145 shows that, in the first resulting analytical data set (FIG. 4B(i)), his age, a time dependent attribute, as seen on February 2007, is 26, and in the second resulting analytical data set (FIG. 4B(ii)), his age, as seen on March 2007, is 27, because his birthday is in February and the attribute value evolves with time.

The system according to the invention may be implemented in the form of hardware in a microcontroller, in the form of software on a software medium or a programmable component in a non-volatile memory executed by a microprocessor.

The method according to this embodiment of the invention provides the advantage that there is no need to redefine the analytical record each time the time factor for analysis changes. Simply by changing the reference time stamp in the time stamped population a new data set adapted to a new desired time reference can be generated. The invention thus provides management of time dependent attributes in a formalised and highly automated manner, with the minimum amount of human intervention. As a result generation of datasets becomes significantly less time consuming and costly. Analytical models for analysing or predicting entity behaviour can be maintained, retrained and back-tested more effectively.

The method according to the embodiment of the invention may find use in many analytical applications such as in entity behaviour analysis, predictive modelling or in the training, scoring, retraining and back-testing of analytical models etc. For example, the method may be used in customer analytics for customer segmentation, i.e. grouping customers having similar characteristics and then using these groups to create lists of customers to target for specific campaigns.

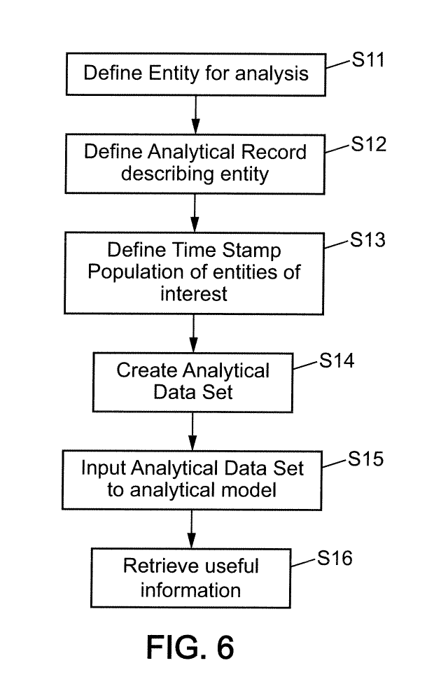

FIG. 6 shows a flow chart outlining steps of a method of analysing data including performing the method of generating a data set for input to an analytical model as described above. Steps S11 to S14 are performed in a similar manner to steps S1 to S4 of FIG. 3. In step S15 the generated analytical dataset is input to an analytical model and the relevant information output from the analytical model is retrieved in step S16.

A potential application of the method according to the invention is for automating advanced analytical models to update, on a scheduled basis, model retraining with the most recent version of data, or simply to apply advanced analytical models (sometimes referred to as ‘scoring’) to the most recent view of the entities of interest. For example, a telecommunications operator may be interested in scoring all its post-paid customers in order to see which customers are most at risk of leaving for a competitor operator and to deploy retention programs for those who are worth retaining. For this, the operator needs to score its entire customer base every month. It is likely that the predictive analytical model used for scoring will use as one of the key influencers some behavioural data (for example: the number of calls given in the last month). In order for the analysis to be fully automated, the process generating the data set compiling information on all post-paid customers with all their attribute values should also be automated. The present invention provides a formal way of automatically gathering the most recent values for attributes that are time dependent.

Another potential application of the method of the invention is in model back-testing. For example, in the previous example, the business owner of the telecommunications operator may decide to ask the analytical team to test an advanced analytical model on past data in order to see how the system would have performed if it had been used in the previous 6 months for detecting the potential leavers. In this case, the advanced analytical model can be used on a data set compiling the attribute values describing the customers as they were 6 months ago, 5 months ago, and so on . . . . The present method provides a way of easily reconstructing the analytical data set compiling information on the post-paid customers as they were known in the system at a given date.

A further potential application is when a proposed advanced analytical model needs more data in order to obtain robust results than a single time period would provide. In the example developed earlier around the telecommunications operator, let us assume that the business owner wishes to have a dedicated model for a specific segment of customers for example (the “5 stars” segment of very valuable clients). In order to ensure that the number of “5 stars” customers potentially leaving for a competitor is correctly detected, he may wish to have a specific model developed for this segment. If the number of people in such a segment is too low, it will be difficult for any modelling technique to find any robust statistical law a way of overcoming this limitation is to compile a training data set that will concatenate “snapshots” of “5 stars” customers not only on the last month, but on several past months: in this case the training data set may contain attributes values for a given customer at different dates. The present invention provides a formal process for deriving attributes values of a given entity of interest at a given time (to compile several versions of a single entity at different stages of its life cycle).

Although the present invention has been described hereinabove with reference to specific embodiments, the present invention is not limited to the specific embodiments, and modifications will be apparent to a skilled person in the art which lie within the scope of the present invention.

1. A method of generating a dataset from data stored in at least one database, for input into an analytical model, the method comprising the steps of:
defining a time stamped population comprising a plurality of tuples, each tuple comprising an entity identifier of an entity for analysis, and at least one reference time stamp associated with the corresponding entity identifier; and
creating a dataset by generating at least one time dependent attribute value for each entity identifier from data associated with said entity identifier in the at least one database, the or each time dependent attribute value representing a time dependent parameter of the corresponding entity identifier and being generated according to a corresponding attribute definition, wherein the or each time dependent attribute value is generated as a function of the or each corresponding reference time stamp.

2. A method according to claim 1 further comprising the preliminary steps of
defining the entity as the object of analysis of the analytical model; and
defining an analytical record for describing the entity, the analytical record comprising at least one time dependent attribute defined by the corresponding attribute definition.

3. A method according to claim 1, wherein the or each attribute definition is expressed in structured query language for execution by a database management system.

4. A method according to claim 1, wherein the time stamped population is defined by structured query language for execution by a database management system.

5. A method according to claim 1, wherein the or each time dependent attribute definition comprises at least one data manipulation operation on data of the one or more databases selected from the group consisting of: extraction, transformation, calculation, aggregation and joining of data.

6. A method according to claim 1, further comprising defining one or more attribute groups wherein each attribute group comprises a set of one or more attributes with similar characteristics.

7. A method of analysing data using an analytical model, the method comprising:
generating a dataset from data stored in at least one database for input to the analytical model;
inputting the dataset to the analytical model; and
performing analysis of data according to the analytical model,
wherein generating the dataset comprises:
defining a time stamped population comprising a plurality of tuples, each tuple comprising an entity identifier of an entity for analysis, and at least one reference time stamp associated with the corresponding entity identifier; and
creating a dataset by generating at least one time dependent attribute value for each entity identifier from data associated with said entity identifier in the at least one database, the or each time dependent attribute value representing a time dependent parameter of the corresponding entity identifier and being generated according to a corresponding attribute definition, wherein the or each time dependent attribute value is generated as a function of the or each corresponding reference time stamp.

8. A method of predicting behaviour of an entity, comprising analysing data using an analytical model, wherein analysing the data comprises:
generating a dataset from data stored in at least one database for input to the analytical model:
inputting the dataset to the analytical model; and
performing analysis of data according to the analytical model,
wherein generating the dataset comprises:
defining a time stamped population comprising a plurality of tuples, each tuple comprising an entity identifier of an entity for analysis, and at least one reference time stamp associated with the corresponding entity identifier; and
creating a dataset by generating at least one time dependent attribute value for each entity identifier from data associated with said entity identifier in the at least one database, the or each time dependent attribute value representing a time dependent parameter of the corresponding entity identifier and being generated according to a corresponding attribute definition, wherein the or each time dependent attribute value is generated as a function of the or each corresponding reference time stamp.

9. A method of training, scoring or back-testing an analytical model comprising analysing data using an analytical model, wherein analysing the data comprises:
generating a dataset from data stored in at least one database for input to the analytical model:
inputting the dataset to the analytical model; and
performing analysis of data according to the analytical model,
wherein generating the dataset comprises:
defining a time stamped population comprising a plurality of tuples, each tuple comprising an entity identifier of an entity for analysis, and at least one reference time stamp associated with the corresponding entity identifier; and
creating a dataset by generating at least one time dependent attribute value for each entity identifier from data associated with said entity identifier in the at least one database, the or each time dependent attribute value representing a time dependent parameter of the corresponding entity identifier and being generated according to a corresponding attribute definition, wherein the or each time dependent attribute value is generated as a function of the or each corresponding reference time stamp.

10. A system for generating a data set from data stored in at least one database, for input into an analytical model, the system comprising:
an input for receiving data from a database;
a processor for defining a time stamped population comprising a plurality of tuples, each tuple comprising an entity identifier of an entity for analysis, and at least one reference time stamp associated with the corresponding entity identifier; and for creating a dataset by generating at least one time dependent attribute value for each entity identifier from data associated with said entity identifier in the at least one database, each attribute value representing a time dependent parameter of the corresponding entity identifier and being generated according to an attribute definition, wherein the or each time dependent attribute value is generated as a function of the corresponding time stamp; and
an output for transmitting the data set to the analytical model.

11. A system according to claim 10 wherein the processor is operable to define the entity as the object of analysis of the analytical model; and to define an analytical record for describing the entity, the analytical record comprising at least one time dependent attribute defined by the corresponding attribute definition.

12. A system according to claim 10, further comprising a user interface for defining the time stamped population, the analytical record, or at least one attribute making up the analytical record.

13. A computer-readable medium having computer-executable instructions to enable a computer system to generate a dataset from data stored in at least one database, for input into an analytical model, the computer-executable instructions comprising:
instructions for defining a time stamped population comprising a plurality of tuples, each tuple comprising an entity identifier of an entity for analysis, and at least one reference time stamp associated with the corresponding entity identifier; and
instructions for creating a dataset by generating at least one time dependent attribute value for each entity identifier from data associated with said entity identifier in the at least one database, the or each time dependent attribute value representing a time dependent parameter of the corresponding entity identifier and being generated according to a corresponding attribute definition, wherein the or each time dependent attribute value is generated as a function of the or each corresponding reference time stamp.
